(19) United States
(12) Patent Application Publication
(10) Pub. No.: US 2010/0307204 A1
(43) Pub. Date: Dec. 9, 2010

(54) LOCK ASSEMBLY WITH DETACHABLE PARTS

(76) Inventor: CHUN TE YU, CHANGHUA COUNTY (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/794,052

(22) Filed: Jun. 4, 2010

(30) Foreign Application Priority Data
Jun. 6, 2009 (TW) 98118969

(51) Int. Cl. E05B 73/00; E05B 15/00; E05B 37/00

(52) U.S. Cl. 70/58; 70/431

(57) ABSTRACT

A lock assembly includes a first lock unit and a second lock unit. The first lock unit includes a first housing and a first locking mechanism disposed in the first housing. The first housing has a receiving hole. The first locking mechanism is configured to be set either in a locking state or in an unlocking state. The second lock unit includes a second housing and a shackle disposed on the second housing. The second housing has a head and a body which is connected with the head and presented to be wedged into the receiving hole of the first housing. Additionally, the first locking mechanism is configured to lock or release the body of the second housing in or from the receiving hole of the first housing when the body is received in the receiving hole.

### BACKGROUND OF INVENTION

1. Field of Invention

The present invention relates to a lock, and in particular to a lock assembly configured for locking a USB connector.

2. Related Prior Art

A lock applied for a USB connector is described in Taiwan Pub. No. 200847542 and includes a receptacle, a confining member and a key-operated lock core. The receptacle is provided for reception a USB connector plug of the USB connector. The confining member includes a hook and a driving member. Rotation of the lock core enables the driving member to drive the hook to hook the USB connector which is received in the receptacle.

Another lock for a USB connector is described in Taiwan Pat. No. 1273161. The lock is configured to lock or unlock a USB connector plug of the USB connector.

Other different types of lock for a female USB connector are described in Taiwan Pat. Nos. I232909, 582422, M346049 and M272844. Each type of the locks is configured to lock a female USB plug of the female USB connector.

### SUMMARY OF INVENTION

The present invention is directed to a lock assembly which includes a first lock unit and a second lock unit detachably engaged with the first lock unit. The first lock unit itself can be used to lock or release an article independent of the second lock unit. Besides, when the first and second lock units are assembled together, the first lock unit can be used to lock or release the second lock unit.

Preferably, the first lock unit includes a first housing defining a receiving hole therein, and a first locking mechanism disposed in the first housing. The second locking mechanism includes a second housing and a shackle. The second housing has a head and a body connected to the head. The body is dimensioned to be wedged into the receiving hole of the first housing. The shackle is disposed on the head. In addition, when the body of the second housing is received in the receiving hole of the first housing, the first locking mechanism can be used to lock or unlock the body according to its state at the time.

This invention provides another lock assembly which includes a first lock unit and a shackle. The first lock unit has a first housing, a first locking mechanism, a control mechanism and a key-operated lock core. The first housing has a receiving hole. The first locking mechanism is disposed in the first housing and configured to lock or unlock a USB connector when the USB connector is received in the receiving hole. In addition, the control mechanism is configured to cooperate with the key-operated lock core to lock or unlock at least one end of the shackle.

This invention provides yet another lock assembly which includes a first lock unit and a shackle. The first lock unit has a first housing, a first locking mechanism and a control mechanism. The first housing has a receiving hole. The first locking mechanism is disposed in the first housing and configured to lock or unlock a USB connector when the USB connector is received in the receiving hole. The first locking mechanism is a combination locking mechanism. The control mechanism is configured to cooperate with a combination lock core of the combination locking mechanism to lock or unlock at least one end of the shackle.

### BRIEF DESCRIPTION OF DRAWINGS

FIG. 1 is an exploded view of a lock assembly in accordance with one embodiment of this invention, showing that a first lock unit and a second lock unit of the lock assembly are separated;

FIG. 2 is a perspective view of the lock assembly shown in FIG. 1, showing that the first and second lock units are coupled together;

FIG. 3 is an exploded view of the first lock unit according to the invention;

FIG. 4 is an exploded view of a combination lock core of the first lock unit according to the invention;

FIG. 5 is a cross section of the combination lock core of FIG. 4;

FIG. 6 is a cross section of the first lock unit and a USB connector before the USB connector is coupled to the first lock unit;

FIG. 7 is a cross section of the first lock unit and the USB connector when they are coupled;

FIG. 8 is an exploded view of the second lock unit according to the invention;

FIG. 9 is a side view of a second housing of the second lock unit according to the invention;

FIGS. 10-13 are cross sectional views of the second lock unit, showing a procedure for attaching or detaching the shackle to or from the second housing;

FIG. 14 illustrates another example of the second lock unit according to the invention;

FIG. 15 illustrates yet another example of the second lock unit according to the invention;

FIG. 16 is a cross section of the lock assembly shown in FIG. 1, showing that the first lock unit is used to lock the second lock unit;

FIGS. 17-19 are partial cross sectional views of the lock assembly, showing a procedure for attaching or detaching the shackle to or from the second lock unit when the first and second lock units are coupled; and

FIG. 20 is a perspective view of a lock assembly in accordance with another embodiment of the invention.

### DETAILED DESCRIPTION OF EMBODIMENTS

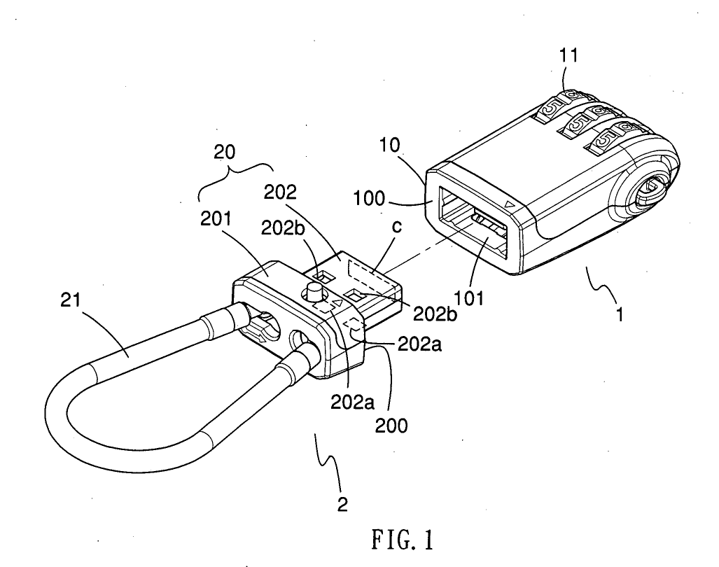

As shown in FIG. 1, a lock assembly in accordance with one embodiment of this invention includes a first lock unit 1 and a second lock unit 2. The first lock unit 1 includes a first housing 10 and a first locking mechanism 11. The first housing 10 has a receiving hole 101 defined in a front end 100 thereof. The first locking mechanism 11 is disposed in the first housing 10 and configured to be set either in a locking state or an unlocking state. The second lock unit 2 includes a second housing 20 and a shackle 21. The second housing 20 has a head 201 and a body 202. The body 202 has its front end joined to a rear end 200 of the head 201 and has a slit C defined in its rear end. The body 202 is slightly smaller than the receiving hole 101 of the first housing 10 so that the body 202 can get in or out of the receiving hole 101. Preferably, the body 202 is dimensioned to fit into the receiving hole 101. The body 202 further defines two pairs of engaging holes 202a and 202b in top and bottom surfaces thereof. The shackle 21 may be a U-shaped clasp made of iron or steel. Alternatively, the shackle 21 may be a steel cable as shown in the drawings. The steel cable is flexible and elastic.

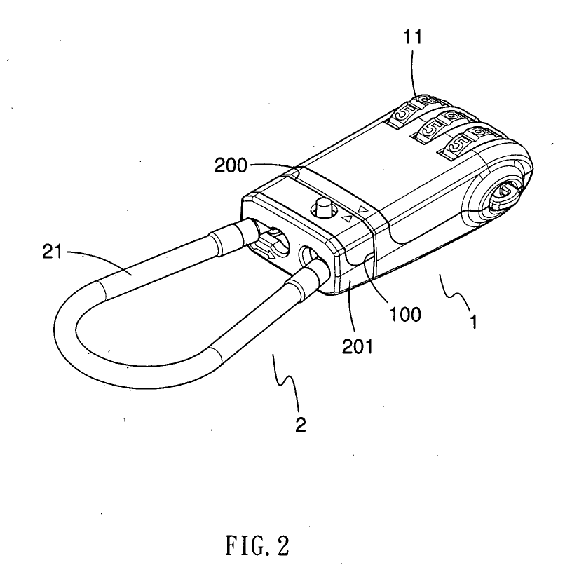

FIG. 2 illustrates that the first and second lock units 1, 2 are assembled together. Because the front end 100 of the first lock unit 1 is substantially equal to the rear end 200 of the second lock unit 2, the first and second lock units 1, 2 can be coupled and integrated into one piece with pleasing appearance. Alternatively, based on the same technical idea, the body 202 of the second lock unit 2 may be formed on the first lock unit 1 instead while the receiving hole 101 be defined in the second lock unit 2. Anyhow, the first and second lock units 1, 2 can be not only assembled together into one piece but also separated from each other, if necessary.

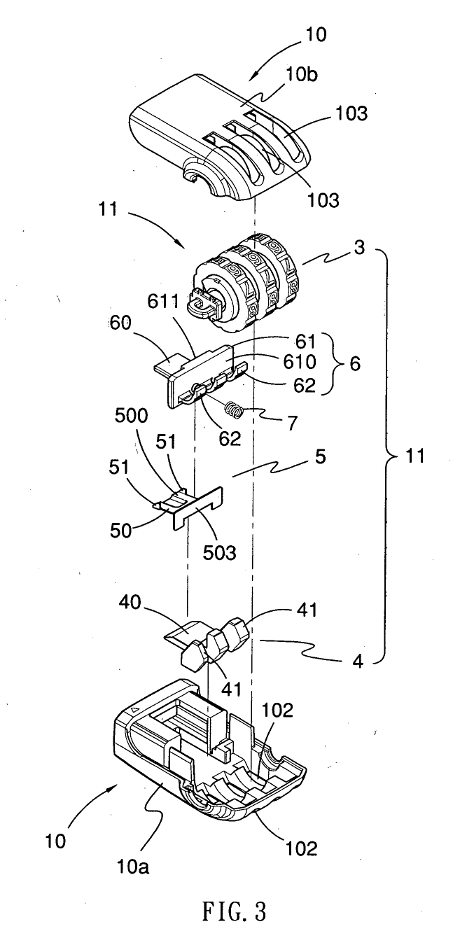

As shown in FIG. 3, the first housing 10 is composed of two half-shells 10a, 10b each having a number of apertures 102 or 103 defined therein. The apertures 102, 103 are aligned with each other in pairs. The first locking mechanism 11 is a combination locking mechanism which includes a push member 4, a fastener 5, a leaf spring assembly 6, a foolproof block 60, a first spring 7 and a combination lock core 3. The push member 4 which may be produced by plastic injection molding includes a base 40 and a plurality of toes 41 formed side by side on a rear end of the base 40. The base 40 has a front end which is tapered. The fastener 5 which may be made by metal punching includes a sheet 50 and two hooks 51. The sheet 50 is formed with a fixing plate 503 at an edge thereof. The two hooks 51 are vertically protruded from a top surface 500 of the sheet 50 and opposite to the fixing plate 503. The leaf spring assembly 6, produced by plastic injection molding, includes a base 61 and a plurality of elastic leaves 62 joined to one side 610 of the base 61. The foolproof block 60 which may be made together with the leaf spring assembly 6 by plastic injection molding is joined to the other side 611 of the base 61. Alternatively, the foolproof block 60 may be separately formed in advance and then be joined to, the base 61 later. It is noted that the elastic leaves 62 may not be necessary to be formed together with the base 61 during the plastic injection molding. Rather, the elastic leaves 62 may be made by metal punching separately. Additionally, the fastener 5 may also be made of plastic material in such a way that the fastener 5 can be formed together with the leaf spring assembly 6 or the base 61 by plastic injection molding.

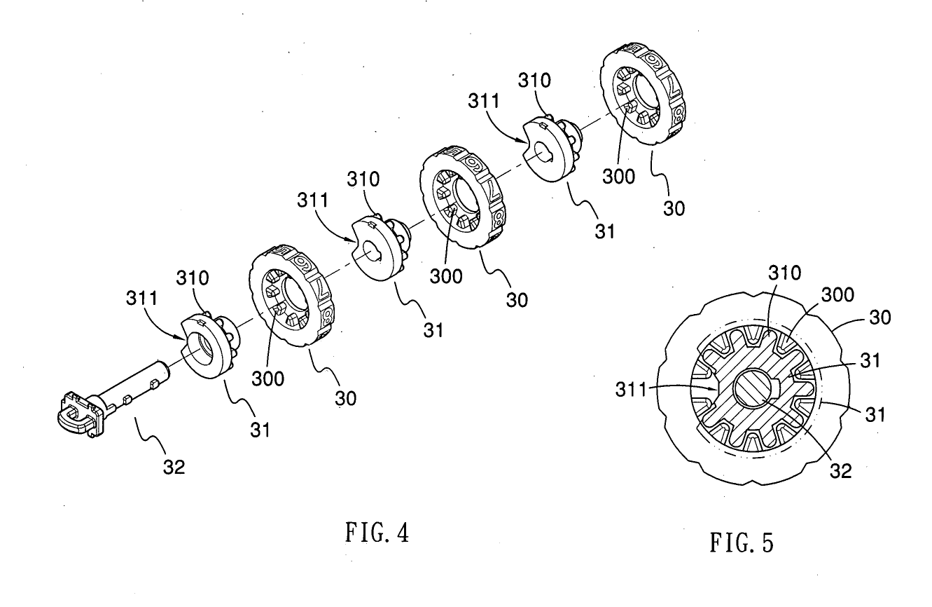

As shown in FIG. 4, the combination lock core 3 includes a plurality of outer wheels 30, a plurality of inner wheels 31 and a shaft lever 32. Each of the outer wheels 30 is labeled with numbers thereon and is formed with a number of teeth 300. Each of the inner wheels 31 is formed with a number of teeth 310 thereon. Each of the inner wheels 31 further has a notch 311 in a peripheral thereof. The shaft lever 32 is disposed through all the inner wheels 31. As shown in FIG. 5, the outer and inner wheels 30, 31 mesh with each other via the teeth 300, 310 so that when the outer wheel 30 is rotated, the corresponding inner wheel 31 is driven to rotate with the outer wheel 30 about the shaft lever 32. By this way, by rotation of the outer wheels 30, locations of the notches 311 of the inner wheels 31 can be changed.

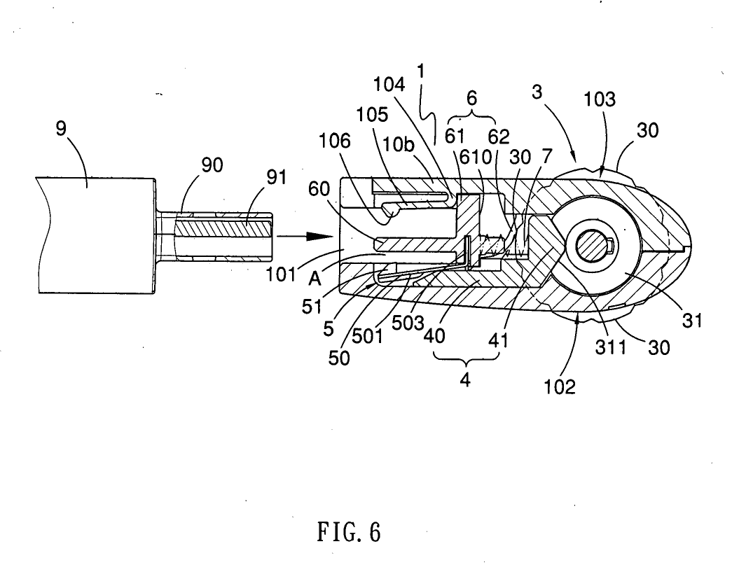

FIG. 6 illustrates details of construction of the first lock unit 1 when the combination lock core 3 is set in an unlocking state. The outer wheels 30 of the combination lock core 3 are partly exposed in the apertures 102, 103 of the first housing 10 and are turned to a preset code, such as 666. The inner wheels 31 of the combination lock core 3 abut against the toes 41 of the push member 4 respectively. Further, after driven by the engaged outer wheels 30, the inner wheels 31 arrives in a position where the toes 41 of the push member 4 are respectively received in the notches 311 of the inner wheels 31. The leaf spring assembly 6 is substantially lapped over the push member 4 but has no effect upon movement of the push member 4. Each of the elastic leaves 62 of the leaf spring assembly 6 abuts against the respective outer wheel 30. A protrusion 104 formed on an inner wall of the upper half-shell 10b bars the way of the base 61 of the leaf spring assembly 6 such that the base 61 is only allowed to move toward the combination lock core 3, but not toward the receiving hole 101. The first lock unit 1 further includes a swingable and flexible fastening member 105. The fastening member 105 has one end joined with the protrusion 104 and the other end formed with a cone-shaped bulge 106. It is noted that the fastening member 105 may be directly formed onto the inner wall of the half-shell 10b, not the protrusion 104. The foolproof block 60 is directed toward the receiving hole 101. The sheet 50 of the fastener 5 is secured on the base 61 by the fixing plate 503 and is inclined at an angle. The sheet 50 leans on the tapered front end of the base 40 of the push member 4. The hook 51 which stands on top of the sheet 50 faces the foolproof block 60 and is spaced at a distance A from the foolproof block 60. The first spring 7 is a compression spring and has one end abutting against the side 610 of the base 61 and the other end against the middle one of the toes 41.

When the first lock unit 1 is in the unlocking state, as depicted in FIG. 6, a USB connector plug 90 which is a part of a USB connector 9, such as USB memory stick, can be inserted, in a direction shown by the arrow, into the receiving hole 101 of the first lock unit 1. However, if the USB connector 9 is turned upside down and then moved toward the receiving hole 101, the USB connector plug 90 of the USB connector 9 cannot be fit into the receiving hole 101 of the first housing 1 because an error-proof block 91 inside the USB connector plug 90 will be blocked by the foolproof block 60 inside the first housing 1.

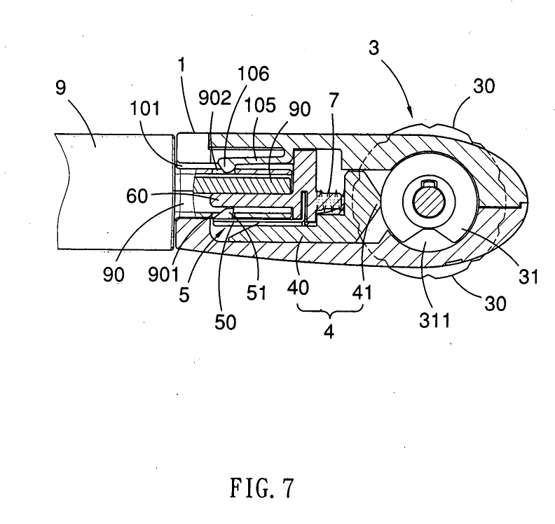

As shown in FIG. 7, the USB connector plug 90 of the USB connector 9 is received in the receiving hole 101 of the first housing 1 and the combination lock core 3 is set in the locking state. At this time, the outer wheels 30 of the combination lock core 3 are turned to an error code, such as 123 or 616 and therefore drive at least one of the inner wheels 31 to move to a position where at least one of the notches 311 of the inner wheel 31 is no more oriented toward the corresponding toe 41 of the push member 4. When the inner wheel 31 rotates, the other rigid portion of the rotating inner wheel 31, not the notch 311, pushes the push member 4 aside toward the receiving hole 101. Movement of the toe 41 presses the first spring 7 to have the first spring 7 save some energy for further restoration. On the other hand, movement of the base 40 of the push member 4 pushes the sheet 50 of the fastener 5 to lean toward the foolproof block 60 at an angle. By this way, the hook 51, which is on the sheet 50, can be hooked into a bottom hole 901 of the USB connector plug 90 so that the USB connector 9 is not allowed to be detached from the first lock unit 1.

In spite that the bulge 106 of the fastening member 105 will be snapped into a top hole 902 of the USB connector plug 90 when the USB connector 9 is inserted into the receiving hole 101, the bulge 106 is only slightly joined in the top hole 902, not really stuck in there. It is because the bulge 106 is cone-shaped with chamfered front and rear ends. In such a fashion, when the combination lock core 3 is set in the unlocking state, as depicted in FIG. 6, where the hook 51 is off the bottom hole 901 of the USB connector plug 90, the USB connector 9 can be easily drawn out of the receiving hole 101.

As described in FIGS. 1-7, the first and second lock units 1, 2 of the lock assembly can be assembled together and is detachable from each other as well. Further, after being detached from the second lock unit 2, the first lock unit 1 itself can be used to lock or unlock a USB connector 9 independent of the second lock unit 2.

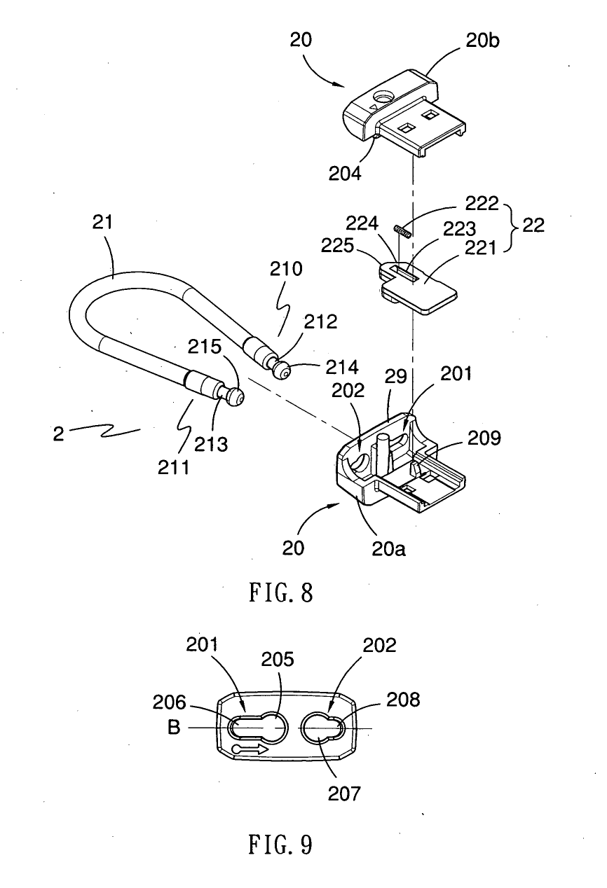

As shown in FIG. 8, the second lock unit 2 further includes a locking part 22. The locking part 22 includes a movable plate 221 and a second spring 222. The movable plate 221 has a longitudinal groove 223, a beveled edge 224 and a front edge 225 adjoining the beveled edge 224. The second housing 20 of the second lock unit 2 is composed of two half-shells 20a, 20b. The lower half-shell 20a defines two locking holes 201, 202 in a front edge 29 thereof. As shown in FIG. 9, the locking hole 201 is composed of a large hole 205 and a narrow hole 206 in communication with the large hole 205. Likewise, the other locking hole 202 has a large hole 207 and a narrow hole 208 in communication with the large hole 207. The large hole 205 of the locking hole 201 is adjacent to the large hole 207 of the other locking hole 202. And the narrow hole 206 of the locking hole 201 is lined up with the narrow hole 208 of the other locking hole 202 along a virtual axial line B. The large holes 205, 207 each is able to receive a distal head 214 of a free section 210 of the shackle 21 or a distal head 215 of a root section 211 of the shackle 21, as depicted in FIG. 8. The width of the narrow hole 206 or 208, smaller than that of the large hole 205 or 207, is dimensioned merely big enough to receive a neck 212 of the free section 210 of the shackle 21 or a neck 213 of the root section 211, but not able to receive the distal head 214 or 215. Furthermore, the upper half-shell 20b is formed with a blocking portion 204 projecting from an inner wall thereof; and the lower half-shell 20a has a guiding portion 209 projecting therefrom.

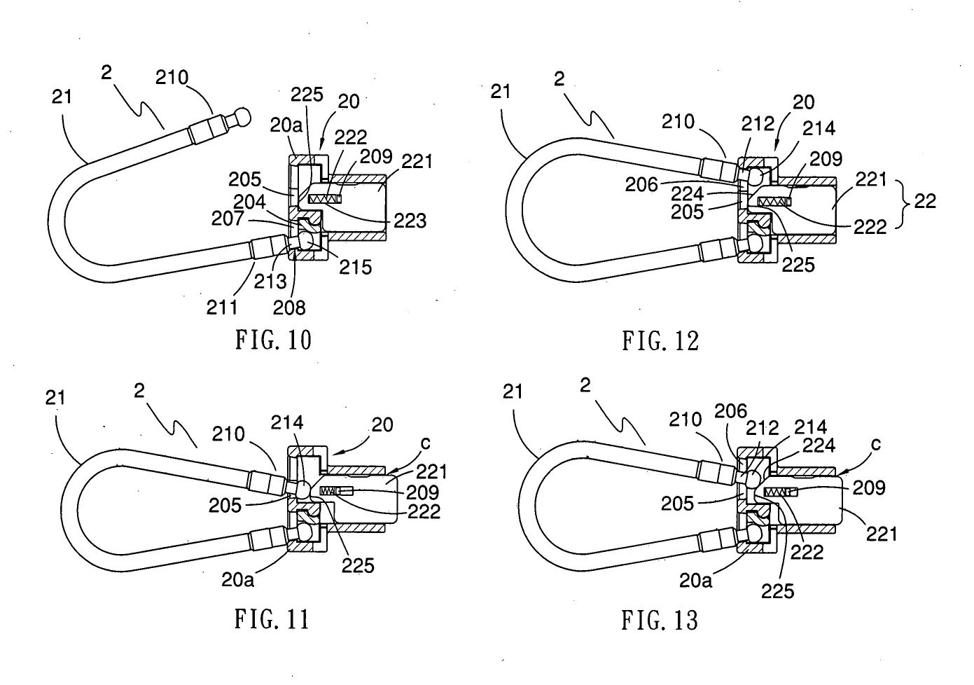

FIG. 10 illustrates that after being inserted into the corresponding large hole 207 of the second housing 20, the distal head 215 of the shackle 21 can slide into the corresponding narrow 208 of the second housing 20 via the neck 213. After the half-shells 20a, 20b, shown in FIG. 8, are coupled, the blocking portion 204 of the upper half-shell 20b is right located in a position blocking the large hole 207, as shown in FIG. 10, so as to prevent the distal head 215 from returning back to the large hole 207. In other words, the distal head 215 can neither be pulled out through the narrow hole 208 because of its size larger than the narrow hole 208, nor be pulled out through the large hole 207 because the large hole 207 is blocked by the blocking portion 204. Thus, the distal head 215 is confined to rotate in the narrow hole 208 only, and thereby the free section 210 of the shackle 21 can rotate about the root section 211 and move outside of the second housing 20. The movable plate 221 is linearly movably mounted in the second housing 20. However, the movable plate 221 may be rotatably mounted in the second housing 20 instead. The guiding portion 209 of the second housing 20 is disposed in the longitudinal groove 223 of the movable plate 221 so that the movable plate 221 can be well confined to move in a straight line. The second spring 222 is also disposed in the longitudinal groove 223 of the movable plate 221, and has one end abutting against the guiding portion 209 and the other end against an inner wall of the longitudinal groove 223 of the movable plate 221. The front edge 225 of the movable plate 221 is located in the large hole 205.

FIG. 11 illustrates that the free section 210 of the shackle 21 is inserted into the corresponding large hole 205 of the second housing 20. At this time, the distal end 214 pushes on the front edge 225 to move the movable plate 221 toward the slit C and to press the second spring 222 that saves energy for further restoration.

FIG. 12 illustrates that the free section 210 of the shackle 21, which may be made up of elastic steel cable, has its neck 212 be pushed from the large hole 205 into the narrow hole 206. At this time, the distal head 214 moves with the neck 212 into the narrow hole 206. Since the distal head 214 is detached from the front edge 225, the movable plate 221 automatically bounces back to its original position by virtue of the energy saved by the second spring 222. At this time, the movable plate 221 has its beveled edge 224 facing toward the distal head 214. Since the distal head 214 is larger than the narrow hole 206, the free section 210 of the shackle 21 cannot be drawn out through the narrow hole 206.

FIG. 13 illustrates that the neck 212 of the free section 210 of the shackle 21 moves along the narrow hole 206 toward the large hole 205. During the movement of the neck 212, the distal head 214 pushes on the beveled edge 224 of the movable plate 221 to move the movable plate 221 toward the slit C. When the distal head 214 completely arrives in the large hole 205, as depicted in FIG. 11, the free section 210 of the shackle 21, with the distal head smaller than the large hole 205, can be pulled out the second housing, as shown in FIG. 10.

As described in FIGS. 8-13, when the second lock unit 2 is detached from the first lock unit 1, it is the locking part 22 that controls whether the free section 210 of the shackle 21 can be detached from the second housing 20. In other words, when the free section 210 is inserted into the second housing 20, as depicted in FIG. 12, the free section 210 is under control of the locking part 22 and therefore cannot be removed from the seconding housing 20 arbitrarily. As such, after detached from the first lock unit 1, the second lock unit 2 itself can be used as a keyring that holds keys or other small items via the shackle 21.

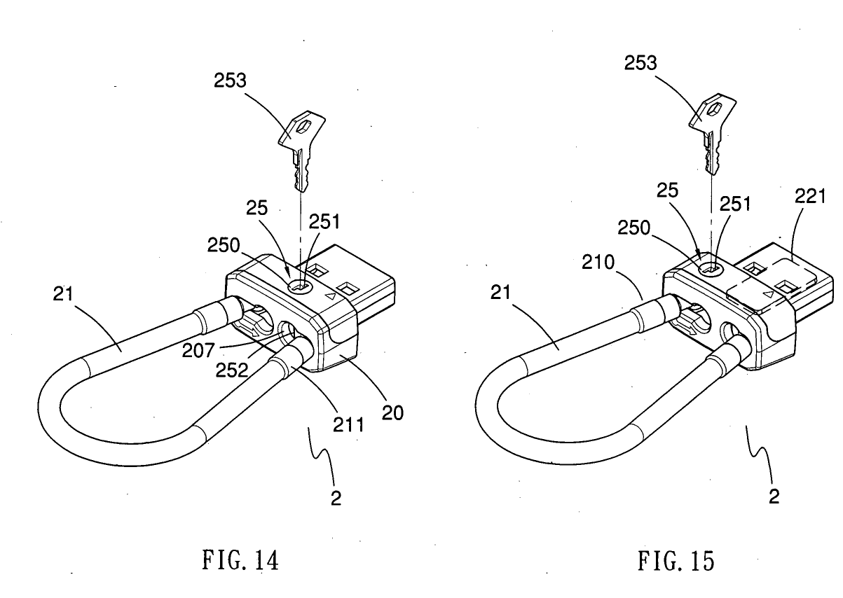

FIG. 14 illustrates another example of the second lock unit 2, which employs a second locking mechanism, such as a key-operated lock core 25 to replace the aforementioned blocking plate 204. Specifically, the key-operated lock core 25 includes a rotor 250 and a stopper 252. The rotor 250 has one end defining a keyhole 251 therein for reception of a match key 253. The key 253 is configured to be inserted into the keyhole 251 and rotated inside the keyhole 251 so as to change positions of the other end of the rotor 250. When the rotor 250 is rotated from a first position to a second position, the other end of the rotor 250 drives the stopper 252 to move to the large hole 207 to block the root section 211 of the shackle 21 from withdrawal of the second housing 20. On the contrary, when the rotor 250 is rotated back to the first position, the other end of the rotor 250 drives the stopper 252 to depart from the large hole 207, which enables the root section 211 of the shackle 21 to be pulled out of the second housing 20 via the large hole 207.

FIG. 15 illustrates yet another example of the second lock unit 2, which is substantially identical to that of FIG. 14, including the key-operated lock core 25, except that the blocking member 204 is still included, not being replaced by the key-operated lock core 25, and the stopper 252 is excluded from this example. In this example, the rotor 250 of the key-operated lock core 25 can be rotated to drive the movable plate 221 to move. Since rotation of the rotor 250 of the key-operated lock core 25 displaces the movable plate 221, the rotor 250 can be rotated by the key 253 to control whether the free section 210 of the shackle 21 be pulled out of the second housing 20. That is, the second lock unit 2 itself can be used as a single lock for locking and unlocking an article.

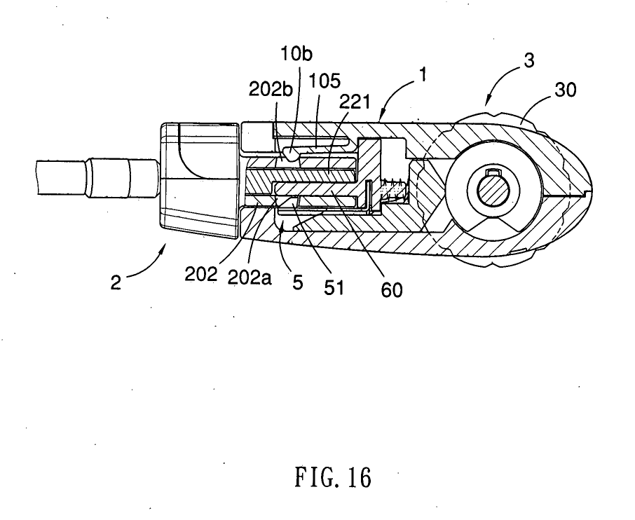

FIG. 16 illustrates that the body 202 of the second lock unit 2 is received in the receiving hole 101 of the first lock unit 1, and the combination lock core 3 is set in the locking state. Since the engaging holes 202a and 202b of the body 202 functions the same with the holes 901, 902 of the USB connector plug 90, the hook 51 of the fastener 5 is indeed hooked in the engaging hole 202a while the bulge 106 of the fastening member 105 is simply slightly snapped in the engaging hole 202b. More information about how the rotation of the outer wheels 30 of the combination lock core 3 is utilized to have the hook 51 of the fastener 5 hooked in or detached from the engaging hole 202a of the second housing 2 can be found in the aforementioned description related to FIGS. 6 and 7. It is understood that the first lock unit 1 not only can be used to lock or unlock the USB connector 9 but also used to lock or unlock the second lock unit 2.

As shown in FIG. 16, the movable plate 221 and the foolproof block 60 are staggered. However, if the movable plate 221 is turned upside down, the movable plate 221, which functions as the error-proof block 91, will be blocked by the foolproof block 60 and be prohibited from being inserted into the receiving hole 101 of the first lock unit 1.

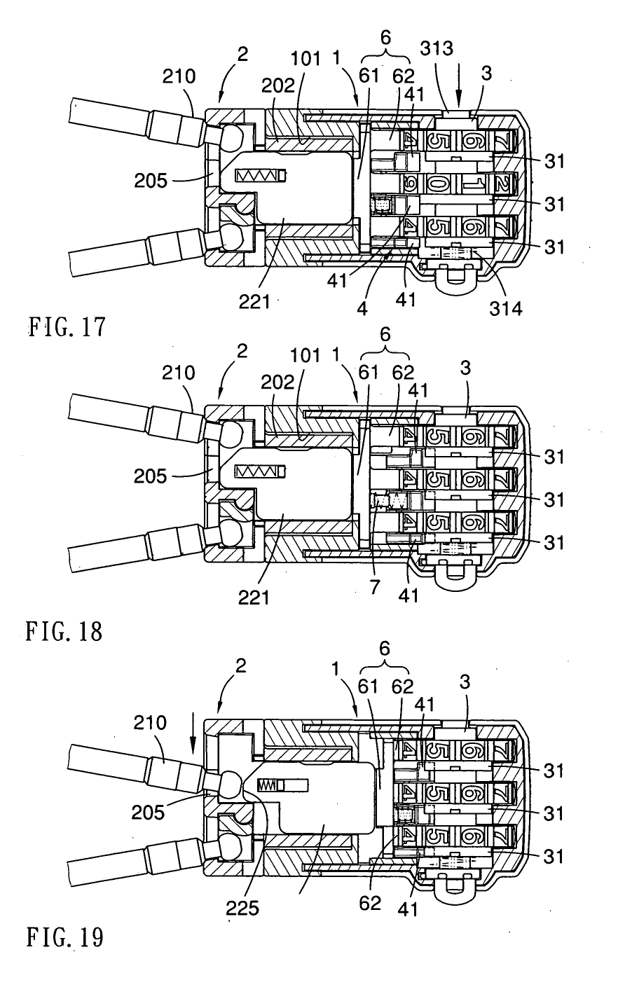

FIG. 17 illustrates that the body 202 of the second lock unit 2 is received in the receiving hole 101 of the first lock unit 1, and the combination lock core 3 is set in the locking state. At this time, the second lock unit 2 is not allowed to be withdrawn from the receiving hole 101. The middle inner wheel 31 of the combination lock core 3, as shown in FIG. 7 or 11, abuts against one side of the toe 41 of the push member 4. The first spring 7 abuts against the base 61 of the leaf spring assembly 6 and is compressed in between the base 61 and the opposite side of the toe 41. The base 61 abuts against the movable plate 221. Thus, the free section 210 of the shackle 21 is blocked by the movable plate 221 from moving toward the large hole 205. That is, the free section 210 of the shackle 21 is locked and prohibited from withdrawal of the second lock unit 2. In the meantime, as shown in FIG. 16, the second lock unit 2 is locked by the first lock unit 1 and can't be pulled out of the first housing 1. The whole lock assembly is in the locking state.

Additionally, exertion of a force upon a portion 313 of the sided one of the inner wheels 31 in a direction indicated by the arrow causes the inner wheels 31 to push one another in such a way that all the three inner wheels 31 can be disengaged from the corresponding outer wheels 30 and have a spring 314 which is on the other side be compressed. At this time, the outer wheels 30 can be dialed to change the code. On the contrary, once the portion 313 is released, the inner wheels 31 will be pushed, one after another, back to their original position by a restoring force of the spring 314 and therefore be engaged with the outer wheels 30 again.

FIG. 18 illustrates that the body 202 of the second lock unit 2 is disposed in the receiving hole 101 of the first housing 1; however, the combination lock core 3 is set in the unlocking state. At this time, please referring to FIG. 6 as well, all the notches 311 of the inner wheels 31 face exactly the corresponding toes 40 so that the toes 40 have been pushed back to their original position by a restoring force of the first spring 7 and therefore wedged into the notches 311 of the inner wheels 31. It should be noted that, at this moment, the base 61 and the toes 41 are a short distance apart, and the first spring 7 returns to its original, uncompressed position. Accordingly, as shown in FIG. 19, the free section 210 of the shackle 21 can be moved in a direction indicated by arrow so as to push the movable plate 221 away from the large hole 205, as shown first in FIG. 13 and then FIG. 11. On the other hand, the movement of the movable plate 221 drives the base 61 to press against all of the elastic leaves 62 and the first spring 7. After that, once the free section 210 is drawn out of the large hole 205, the base 61 and the movable plate 221 can be pushed back to the original position by a restoring force exerted by the elastic leaves 62 and the. first spring 7. At this moment, the detail construction inside the first lock unit 1 is presented like the one shown in FIG. 6 while the detail construction inside the second lock unit 2 is like the one shown in FIG. 10.

As described in FIGS. 17-19, when the first and second lock units 1, 2 are assembled together, they are integrated as one complete padlock, as shown in FIG. 2. When the first locking mechanism 11 is set in the locking state, the free section 210 of the shackle 21 is not allowed to be detached from the head 201 of the second lock unit 2. On the contrary, when the first locking mechanism 11 is set in the unlocking state, the free section 210 of the shackle 21 is allowed to be detached from the head 201 of the second lock unit 2.

That is, the first and second lock units 1, 2 can be combined together as a lock for locking an article.

It is understood that when the first and second lock units 1, 2 are assembled together, they are integrated as a dual lock. Both the first locking mechanism 11 (such as the one including the combination lock core 3) and the second locking mechanism 12 (such as the one including the key-operated lock core 25) can be used to lock or unlock.

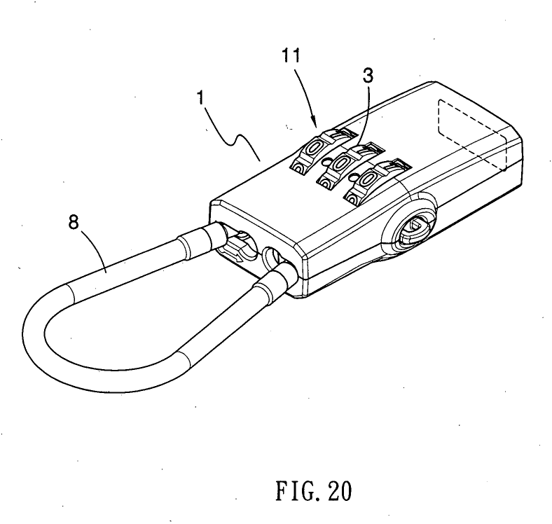

FIG. 20 provides a perspective view of a first lock unit 1 in an alternate embodiment. The detail construction of the first lock unit 1 of FIG. 20 is substantially identical to the one described in FIG. 2, except that the first lock unit 1 of FIG. 20 further includes a shackle 8 and a control mechanism (not shown). The control mechanism is configured to independently lock or release one or two ends of the shackle 8. Alternatively, the control mechanism cooperates with the combination lock core 3 (or another key-operated lock core) to lock or release one or two ends of the shackle 8. The first locking mechanism 11 of the first lock unit 1, as described above, is configured to lock or unlock either a USB connector plug 90 or a second lock unit 2 (as described above) in or from the receiving hole 101. Thus, the first lock unit 1 of this embodiment and the second lock unit can be coupled and become a special padlock with two shackles 8, 21 at opposite ends. The two shackles 8, 21 each may be used to grasp an article. For instance, the shackle 21 is used to tie a handle of a luggage case while the other shackle 8 is used to tie a pair of zipper heads of the luggage case. After that, the control mechanism and/or the combination lock core 3 (or another key-operated lock core) is used to lock the two shackles 8, 21.

It will be appreciated that a particular embodiment of the invention has been shown and described, so anyone can learn from the teaching to know that the present invention meets the requirement of the industrial applicability and the inventive step. Further, the requirement of novelty is met as well since there is no similar product or publication found among the products of the same kind. Accordingly, it is submitted that the present invention fulfills the requirements of the patentability of Utility patent.

The invention claimed is:

1. A lock assembly comprising:
a first lock unit including a first housing having a receiving hole, and a first locking mechanism disposed in the first housing; the first locking mechanism configured to be set either in a locking state or in an unlocking state; and
a second lock unit including a second housing and a shackle disposed on the second housing; the second housing having a head and a body which is connected with the head and presented to be wedged into the receiving hole of the first housing of the first lock unit;
wherein the first locking mechanism is configured to lock or release the body of the second lock unit in or from the receiving hole of the first housing while the body is received in the receiving hole.

2. The lock assembly of claim 1, wherein the body of the second lock unit defines at least one engaging hole in a top surface thereof; the first locking mechanism includes at least one hook; when the first lock unit is set in the locking state, the hook is allowed to move to a specific position where the hook is hooked into the engaging hole of the second lock unit; and when the first lock unit is set in the unlocking state, the hook is allowed to depart from the specific position.

3. The lock assembly of claim 2, wherein the body of the second lock unit further defines another engaging hole in a bottom surface thereof; the first lock unit further includes an elastically swingable fastening member; the fastening member has one end connected to an inner wall of the first housing and the other end formed with a cone-shaped bulge; and the bulge is constructed to be fit into the bottom engaging hole of the body.

4. The lock assembly of claim 1, wherein the second housing of the second lock unit defines two locking holes in a side surface thereof; and the shackle has its two opposite ends to be received in the two locking holes of the second housing for engagement with the second housing of the second lock unit.

5. The lock assembly of claim 4, wherein the second lock unit further includes a second locking mechanism disposed in the second housing for locking or releasing at least one end of the shackle in or from the respective locking hole of the second housing.

6. A lock assembly for locking a USB connector; the lock assembly comprising a lock unit and a shackle; the lock unit including:
a housing having a receiving hole;
a locking mechanism disposed in the housing and configured to lock or release the USB connector in or from the receiving hole;
a key-operated lock core; and
a control mechanism configured to cooperate with the key-operated lock core to lock or release at least one end of the shackle.

7. A lock assembly for locking a USB connector; the lock assembly comprising a lock unit and a shackle; the lock unit including:
a housing having a receiving hole;
a combination locking mechanism disposed in the housing and . configured to lock or release the USB connector in or from the receiving hole;
a control mechanism configured to cooperate with a combination lock core of the combination locking mechanism to lock or release at least one end of the shackle.
